(19) United States
(12) Patent Application Publication
(10) Pub. No.: US 2016/0012816 A1
(43) Pub. Date: Jan. 14, 2016

(54) SIGNAL PROCESSING DEVICE, HEADPHONE, AND SIGNAL PROCESSING METHOD

(71) Applicant: YAMAHA CORPORATION, Hamamatsu-shi, Shizuoka (JP)

(72) Inventor: Morishige FUJISAWA, Hamamatsu-shi (JP)

(21) Appl. No.: 14/772,614

(22) PCT Filed: Jan. 17, 2014
(86) PCT No.: PCT/JP2014/050781

§ 371 Date: Sep. 3, 2015

(30) Foreign Application Priority Data
Mar. 12, 2013 (JP) 2013-048890

(51) Int. Cl. G10K 11/178; H04R 3/00; H04R 1/10

(52) U.S. Cl. CPC G10K 11/1786; H04R 1/1083; H04R 3/005; G10K 2210/3031; G10K 2210/3046

(57) ABSTRACT

A signal processing device includes: an input unit that accepts an input of a sound-source signal; a sound acquisition unit that acquires ambient sound to generate a sound-acquisition signal; a localization processing unit that processes at least one of the sound-source signal and the sound-acquisition signal so that a first position and a second position are different from each other, and mixes the sound-source signal and the sound-acquisition signal at least one of which is processed, to generate an addition signal, the first position being where a sound image based on the sound-source signal is localized, the second position being where a sound image based on the sound-acquisition signal being localized; and an output unit that outputs the addition signal.

### TECHNICAL FIELD

The present invention relates to a signal processing device, a headphone, and a signal processing method.

Priority is claimed on Japanese Patent Application No. 2013-048890 filed Mar. 12, 2013, the content of which is incorporated herein by reference.

### BACKGROUND ART

A sound-isolating headphone being a headphone having high sound insulation, enables listening to a sound-source sound (audio sound) without any leakage of sound to the surroundings. As an application example of the sound-isolating headphone, there is known a noise-canceling headphone. The noise-canceling headphone acquires ambient sound by a microphone, and adds the ambient sound to the audio sound in an opposite phase, thereby negating the ambient sound that reaches a user's ears.

There is an issue that these headphones also interrupt required sound (for example, a calling voice or the like from nearby people).

In view of the above, for example, the noise-canceling headphone disclosed in Patent Document 1 has a talk-through function for outputting only the ambient sound acquired by the microphone, to enable setting a state the same as with the headphone taken off.

However, when the talk-through function is turned on, the audio sound is not output. Accordingly, the headphone disclosed in Patent Document 1 extracts only a specific band (voice band) from the sound acquired by the microphone, and mixes the extracted sound with the audio sound. Due to this configuration, the listener can listen to the audio sound without blocking a human voice.

### PRIOR ART DOCUMENT

### Patent Document

[Patent Document 1] Japanese Unexamined Patent Application, First Publication No. 2012-63483

### SUMMARY OF THE INVENTION

### Problem to be Solved by the Invention

However, the headphone disclosed in Patent Document 1 simply mixes the sound acquired by the microphone with the audio sound. Because of this, the sound acquired by the microphone, and the audio sound, overlap on each other, and become hard to listen to.

An exemplary object of the present invention is to provide a signal processing device, a headphone, and a signal processing method that make it easy to listen to the sound-source sound and the ambient sound, without the sound-source sound and the ambient sound being overlapped on each other.

### Means for Solving the Problem

A signal processing device according to an aspect of the present invention includes: an input unit that accepts an input of a sound-source signal; a sound acquisition unit that acquires ambient sound to generate a sound-acquisition signal; a localization processing unit that processes at least one of the sound-source signal and the sound-acquisition signal so that a first position and a second position are different from each other, and mixes the sound-source signal and the sound-acquisition signal at least one of which is processed, to generate an addition signal, the first position being where a sound image based on the sound-source signal is localized, the second position being where a sound image based on the sound-acquisition signal being localized; and an output unit that outputs the addition signal.

Because the signal processing device described above performs processing to localize the sound-source sound and the ambient sound at different positions, while mixing the ambient sound acquired by the sound acquisition unit with the sound-source sound, these sounds do not overlap on each other. Accordingly, a user can listen to both the sound-source sound and the ambient sound clearly.

Moreover, according to the signal processing device described above, the user can listen to both the sound-source sound and the ambient sound clearly without processing to extract only the voice band. Because of this, the user can also listen to the sound including a main component (for example, the sound of an emergency vehicle) other than the voice band clearly.

As a result, the user can listen to both the sound-source sound and the ambient sound clearly, without any leakage of sound-source sound such as musical sound to the surroundings.

A headphone according to an aspect of the present invention includes: the signal processing device described above; and a headphone unit that emits sound based on the addition signal.

A signal processing method according to an aspect of the present invention includes: accepting an input of a sound-source signal; acquiring ambient sound to generate a sound-acquisition signal; processing at least one of the sound-source signal and the sound-acquisition signal so that a first position and a second position are different from each other, the first position being where a sound image based on the sound-source signal is localized, the second position being where a sound image based on the sound-acquisition signal is localized; mixing the sound-source signal and the sound-acquisition signal at least one of which is processed, to generate an addition signal; and outputting the addition signal.

### Effect of the Invention

According to an embodiment of the present invention, the sound-source sound and the ambient sound do not overlap on each other, and both the sound-source sound and the ambient sound become easy to listen to.

### BRIEF DESCRIPTION OF THE DRAWINGS

FIG. 1A is a diagram showing a configuration of a headphone according to a first embodiment.

FIG. 1B is a block diagram showing a configuration of a signal processing unit according to the first embodiment.

FIG. 2A is a diagram showing a configuration of a headphone according to a second embodiment.

FIG. 2B is a block diagram showing a configuration of a signal processing unit according to the second embodiment.

FIG. 3 is a diagram showing a configuration of a signal processing unit according to an application example of the first embodiment.

FIG. 4A is a diagram showing a configuration of a headphone according to a third embodiment.

FIG. 4B is a block diagram showing a configuration of a signal processing unit according to the third embodiment.

FIG. 5A is a diagram showing a configuration of a headphone according to a fourth embodiment.

FIG. 5B is a block diagram showing a configuration of a signal processing unit according to the fourth embodiment.

FIG. 6 is a diagram showing a configuration of a localization processing unit according to the fourth embodiment.

### EMBODIMENTS FOR CARRYING OUT THE INVENTION

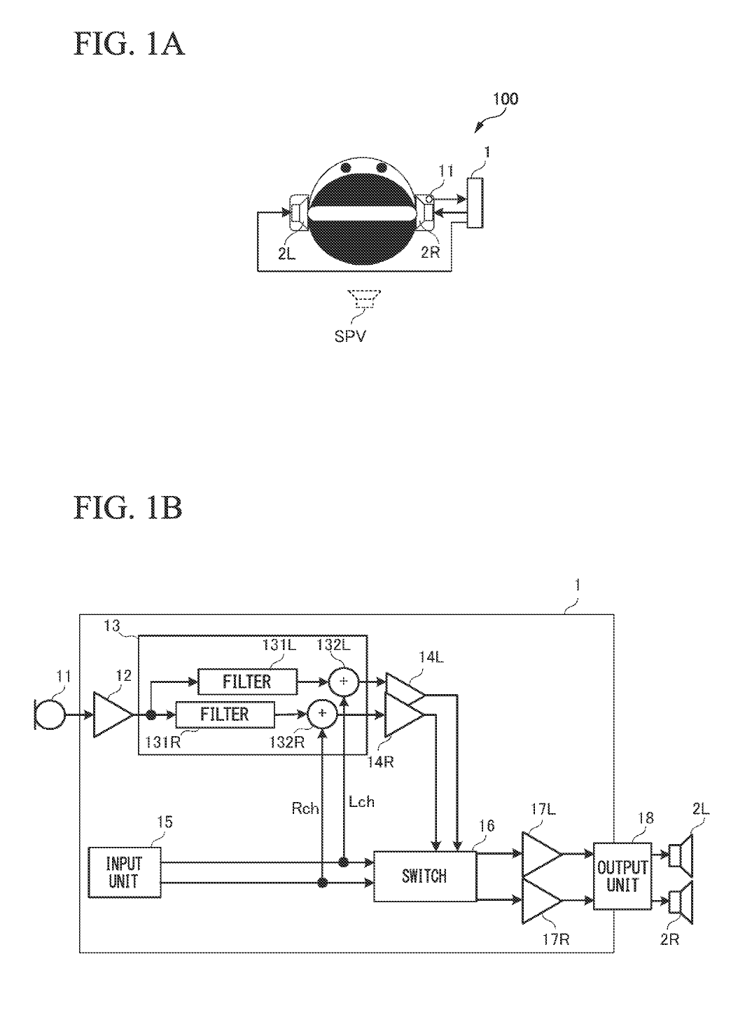

FIG. 1A is a schematic diagram of a headphone 100 according to a first embodiment. The headphone 100 is a sound-isolating type headphone. As shown in FIG. 1A, the headphone 100 includes a signal processing unit 1, a headphone unit 2L, a headphone unit 2R, and a microphone 11. The signal processing unit 1 may be an example of a processing device. All the various signals in the present embodiment are digital signals unless particularly described. Illustrations and descriptions of a configuration to convert various signals from analog to digital signals and a configuration to convert various signals from digital to analog signals are omitted. The headphone unit 2L is arranged on the left ear of a listener. The headphone unit 2R is arranged on the right ear of the listener.

The microphone 11 is provided near the headphone unit 2R to acquire ambient sound, and outputs a sound-acquisition signal. However, the installation position of the microphone 11 is not limited to this example. For example, the microphone 11 may be provided near the headphone unit 2L, may be provided near the signal processing unit 1, or may be built into the signal processing unit 1.

The headphone 100 according to this embodiment performs processing so that a position at which a sound image based on the ambient sound (a sound-acquisition signal) acquired by the microphone 11 is localized and a position at which a sound image based on a sound-source sound (an audio signal) is localized, are different from each other. A head-related transfer function (hereunder, referred to as HRTF) corresponding to a head shape of the listener, is used to localize these sounds at the different positions.

The HRTF is an impulse response expressing the size of sound reaching the left and right ears from a virtual loudspeaker (an SPV in FIG. 1A) installed at a certain position, an arrival time, and a difference of a frequency characteristic. In the example shown in FIG. 1A, the headphone 100 adds the HRTF for localizing at the virtual loudspeaker SPV positioned at the back of the head, to at least one of the ambient sound and the sound-source sound. The headphone 100 supplies the ambient sound and the sound-source sound, at least one of which is added with the HRTF, to the headphone unit 2L and the headphone unit 2R. As a result, the listener can virtually perceive that the ambient sound or the sound-source sound is emitted from the virtual loudspeaker SPV.

FIG. 1B is a block diagram showing a configuration of the signal processing unit 1. The signal processing unit 1 includes a microphone amplifier 12, a localization processing unit 13, a level adjuster 14L, a level adjuster 14R, an input unit 15, a switch 16, a headphone amplifier 17L, a headphone amplifier 17R, and an output unit 18. The signal processing unit 1 may be a dedicated unit of the headphone 100, but is not limited thereto. The respective configurations of the signal processing unit 1 can be realized by using a general information processing device (for example, a smart phone).

The input unit 15 accepts an input of a sound-source signal (audio signal) from an external device such as an audio player (or an audio reproduction functional unit or the like of the own device). The localization processing unit 13 and the switch 16 accept an input of the audio signal input to the input unit 15. In this example, the respective localization processing unit 13 and switch 16 accept an input of two-channel audio signals of an L-channel signal Lch and an R-channel signal Rch from the input unit 15. The microphone amplifier 12 at a front end amplifies the ambient sound acquired by the microphone 11 (a sound-acquisition signal) and inputs the amplified sound-acquisition signal to the localization processing unit 13.

The localization processing unit 13 includes a filter to convolute the impulse response of the HRTF. The localization processing unit 13 adds the HRTF to the sound-acquisition signal input from the microphone amplifier 12, to thereby cause the position at which the sound image based on the sound-acquisition signal is localized to be different from that of the audio signal. The localization processing unit 13 may be provided as hardware. The localization processing unit 13 may be realized as software by executing a predetermined program by a CPU in the information processing device such as a smart phone.

As shown in FIG. 1B, the localization processing unit 13 includes a filter 131L, a filter 131R, an adder 132L, and an adder 132R.

The filter 131L adds an HTRF (B_{L}) corresponding to a route from the virtual loudspeaker SPV at the back of the listener to his or her left ear, to the sound-acquisition signal. The adder 132L mixes the sound-acquisition signal added with the HRTF (B_{L}), with the L-channel audio signal.

Similarly, the filter 131R adds an HTRF (B_{R}) corresponding to a route from the virtual loudspeaker SPV at the back of the listener to his or her right ear, to the sound-acquisition signal. The adder 132R mixes the sound-acquisition signal added with the HTRF (B_{R}), with the R-channel audio signal.

The level adjuster 14L and the level adjuster 14R adjust respective levels of the L-channel audio signal and the R-channel audio signal input from the localization processing unit 13, and input them to the switch 16.

The switch 16 inputs the L-channel audio signal and the R-channel audio signal input from the input unit 15, or the L-channel audio signal and the R-channel audio signal input from the level adjuster 14L and the level adjuster 14R, to a subsequent stage according to a user's operation. The headphone amplifier 17L and the headphone amplifier 17R respectively amplify the L-channel audio signal and the R-channel audio signal input from the switch 16, and input the signals to the output unit 18. The output unit 18 inputs the L-channel audio signal input from the headphone amplifier 17L and the headphone amplifier 17R, to the headphone unit 2L and the headphone unit 2R.

When the L-channel audio signal and the R-channel audio signal input from the input unit 15 are input to the subsequent stage, the sound-acquisition signal of the microphone 11 is not output from the headphone unit 2L and the headphone unit 2R. Accordingly, in this case, the headphone 100 functions as a normal sound-isolating headphone.

On the other hand, the sound-acquisition signal of the microphone 11 is mixed in the L-channel audio signal and the R-channel audio signal input from the level adjuster 14L and the level adjuster 14R. Consequently, the user can listen to both the audio sound and the ambient sound. The sound-acquisition signal of the microphone 11 has been subjected to the processing to be localized at a position of the virtual loudspeaker SPV at the back of the listener. Because of this, in the user, the audio sound is lateralized, and the ambient sound is localized at a rear position. Consequently, the user can listen to the audio sound without any leakage to the surroundings, and can listen to both the audio sound and the ambient sound clearly. As a result, the user can naturally listen to the sound-source sound without being disturbed by the ambient sound, and does not fail to listen to the necessary sound (for example, the sound of emergency vehicles).

In the example in FIG. 1A, the HRTF for localizing at the position of the virtual loudspeaker SPV at the back of the listener is added to the sound-acquisition signal of the microphone 11. However, the localization process is not limited thereto, and may be any method such as adjustment of left and right mixing balance, or sound volume control. For example, when the mixing balance is to be adjusted, the localization processing can be realized by inputting the sound-acquisition signal of the microphone 11 to the headphone unit 2L, and inputting the audio signal to the headphone unit 2R. The localization processing can also be realized by analog processing.

The sound image based on the sound-acquisition signal of the microphone 11 may be lateralized, and the sound image based on the audio signal may be localized at the position of the virtual loudspeaker SPV at the back of the listener. The HRTF may be added to both the sound-acquisition signal and the audio signal.

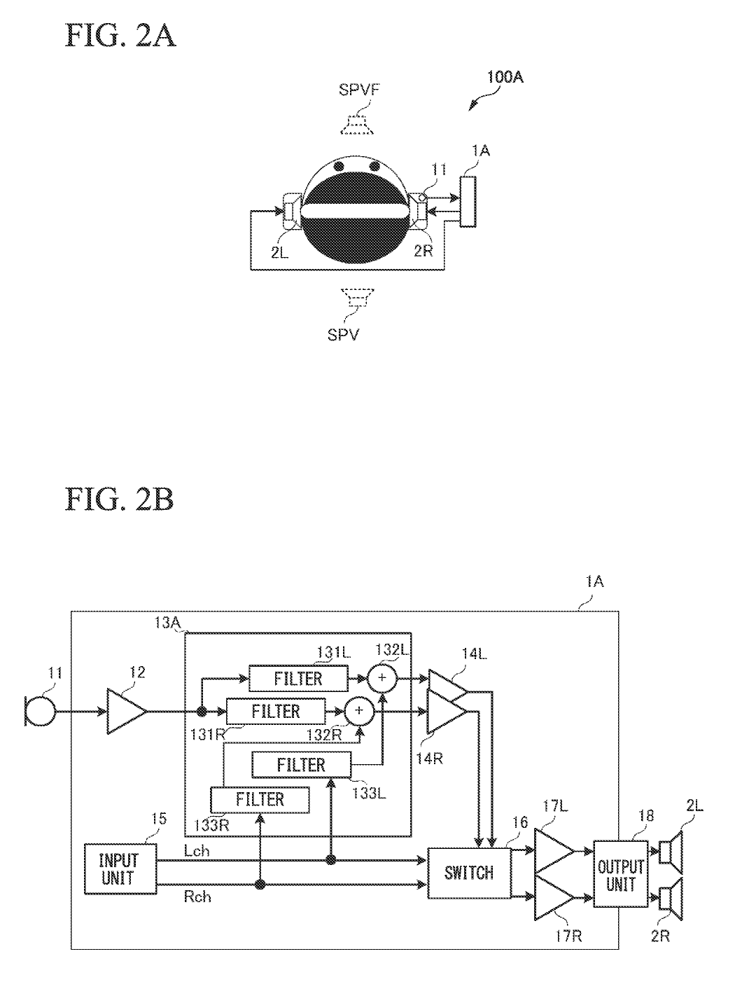

FIG. 2A is a schematic diagram of a headphone 100A according to a second embodiment. FIG. 2B is a block diagram showing a configuration of a signal processing unit 1A according to the second embodiment. The headphone 100A is a sound-isolating type headphone.

Parts of the configuration shown in FIG. 2A and FIG. 2B similar to those in FIG. 1A and FIG. 1B are denoted by the same reference symbols, and explanation thereof is omitted. A localization processing unit 13A in this example further includes a filter 133L and a filter 133R.

The filter 133L adds an HTRF (F_{L}) corresponding to a route from a virtual loudspeaker SPVF at the front of the listener to his or her left ear, to the L-channel audio signal. An adder 132L mixes an audio signal added with the HTRF (F_{L}), with a sound-acquisition signal added with the HTRF (B_{L}) to generate an addition signal.

Similarly, the filter 133R adds an HTRF (F_{R}) corresponding to a route from the virtual loudspeaker SPVF at the front of the listener to his or her right ear, to the audio signal. An adder 132R mixes the audio signal added with the HTRF (F_{R}), with the sound-acquisition signal added with the HTRF (B_{R}) to generate an addition signal.

As a result, a sound image based on the sound-acquisition signal is localized at a position of the virtual loudspeaker SPV at the back of the listener. Moreover, a sound image based on the audio signal is localized at a position of the virtual loudspeaker SPVF at the front of the listener. Consequently, also in this example, the user can listen to the audio sound without any leakage to the surroundings, and can listen to both the audio sound and the ambient sound clearly.

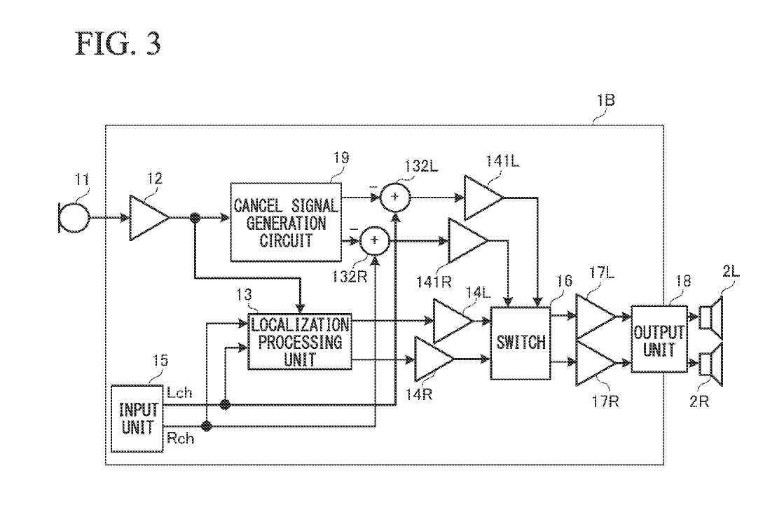

FIG. 3 is a block diagram showing a configuration of a signal processing unit 1B according to an application example of the first embodiment. Parts of the configuration shown in FIG. 3 similar to those in FIG. 1B are denoted by the same reference symbols, and explanation thereof is omitted. The signal processing unit 1B in this example includes a cancel signal generation circuit 19 that accepts an input of the sound-acquisition signal of the microphone 11. The cancel signal generation circuit 19 is a circuit that generates a cancel signal that simulates sound of the ambient sound that the listener can hear. That is, the cancel signal generation circuit 19 is formed of a filter that simulates the sound insulation characteristic of the sound-isolating headphone.

The adder 132L and the adder 132R respectively mix the cancel signal in an opposite phase which is generated by the cancel signal generation circuit 19, with the L-channel audio signal and the R-channel audio signal respectively. A level adjuster 141L and a level adjuster 141R adjust the levels of the L-channel audio signal and the R-channel audio signal mixed with the cancel signal in the opposite phase, and input the signals to the switch 16.

Consequently, when the switch 16 is set so as not to output the sound-acquisition signal, the ambient sound having reached the listener's ears is canceled by the cancel signal in the opposite phase that is mixed in the L-channel audio signal and the R-channel audio signal. Because of this, the headphone 100 according to this example functions as a noise cancelling headphone.

In this example, an example is shown in which the sound-acquisition signal acquired by a single microphone 11 is input to the localization processing unit 13 and the cancel signal generation circuit 19. However, the number of microphones is not limited to one. A plurality of microphones may be provided, and the sound-acquisition signals acquired by the respective microphones may be input to the cancel signal generation circuit 19.

The cancel signal generation circuit 19 can also be applied to the signal processing unit 1A shown in FIG. 2B (and a signal processing unit 1C and a signal processing unit 1D described later).

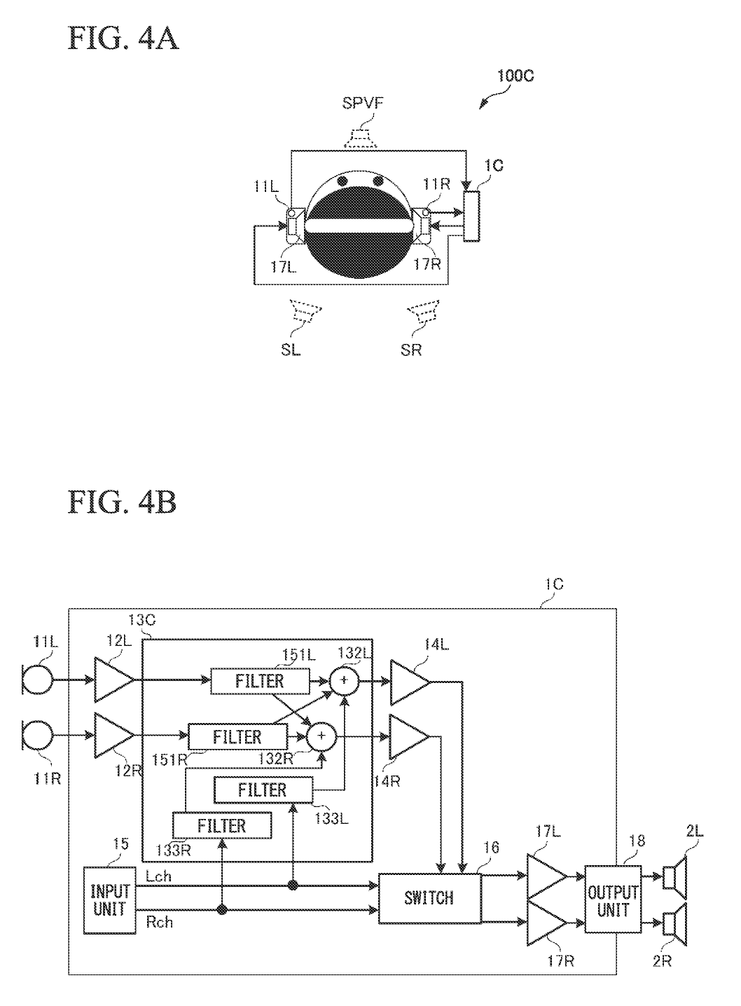

FIG. 4A is a schematic diagram of a headphone 100C according to a third embodiment. FIG. 4B is a block diagram showing a configuration of the signal processing unit 1C according to the third embodiment. Parts of the configuration shown in FIG. 4A and FIG. 4B similar to those in FIG. 2A and FIG. 2B are denoted by the same reference symbols and explanation thereof is omitted. The headphone 100C is a sound-isolating type headphone.

The headphone 110C in this example includes two microphones, that is, a microphone 11L and a microphone 11R. The headphone 110C localizes sound images based on the sounds respectively acquired by the microphone 11L and the microphone 11R at different positions. The microphone 11L mainly acquires the sound of the ambient sound that is on the left side of the listener. The microphone 11R mainly acquires the sound of the ambient sound that is on the right side of the listener.

The signal processing unit 1C includes a microphone amplifier 12L that amplifies a sound-acquisition signal of the microphone 11L, and a microphone amplifier 12R that amplifies a sound-acquisition signal of the microphone 11R. A localization processing unit 13C includes a filter 151L and a filter 151R instead of the filter 131L and the filter 131R in FIG. 2B.

The filter 151L adds an HRTF (SL_{L}) corresponding to a direct route from a virtual loudspeaker SL at the left rear of the listener to his or her left ear, to the sound-acquisition signal. The filter 151L inputs the sound-acquisition signal added with the HRTF (SL_{L}), to an adder 132L. Moreover, the filter 151L adds an HRTF (SL_{R}) corresponding to an indirect route from the virtual loudspeaker SL to the listener's right ear, to the sound-acquisition signal, and inputs the sound-acquisition signal added with the HRTF (SL_{R}), to an adder 132R.

Similarly, the filter 151R adds an HRTF (SR_{R}) corresponding to a direct route from a virtual loudspeaker SR at the right rear of the listener to his or her right ear, to the sound-acquisition signal. The filter 151R inputs the sound-acquisition signal added with the HRTF (SR_{R}), to the adder 132R. Moreover, the filter 151R adds an HRTF (SR_{L}) corresponding to an indirect route from the virtual loudspeaker SR to the listener's left ear, to the sound-acquisition signal. The filter 151R inputs the sound-acquisition signal added with the HRTF (SR_{L}), to the adder 132L.

The adder 132L mixes the audio signal added with the HTRF (F_{L}), the sound-acquisition signal of the microphone 11L added with the HTRF (SL_{L}), and the sound-acquisition signal of the microphone 11R added with the HTRF (SR_{L}). Similarly, the adder 132R mixes the audio signal added with the HTRF (F_{R}), the sound-acquisition signal of the microphone 11R added with the HTRF (SR_{R}), and the sound-acquisition signal of the microphone 11L added with the HTRF (SL_{R}).

As a result, the localization processing unit 13C can localize the ambient sound on the left side, in the virtual loudspeaker SL at the left back of the listener, and can localize the ambient sound on the right side, in the virtual loudspeaker SL at the right back of the listener. Consequently, the listener can perceive in which direction the ambient sound is generated, and can thus acquire a sense of left and right direction.

In this example, the audio sound is localized at the position of the virtual loudspeaker SPVF at the front of the listener. However, it is not limited thereto. The audio sound may be lateralized without performing the localization processing.

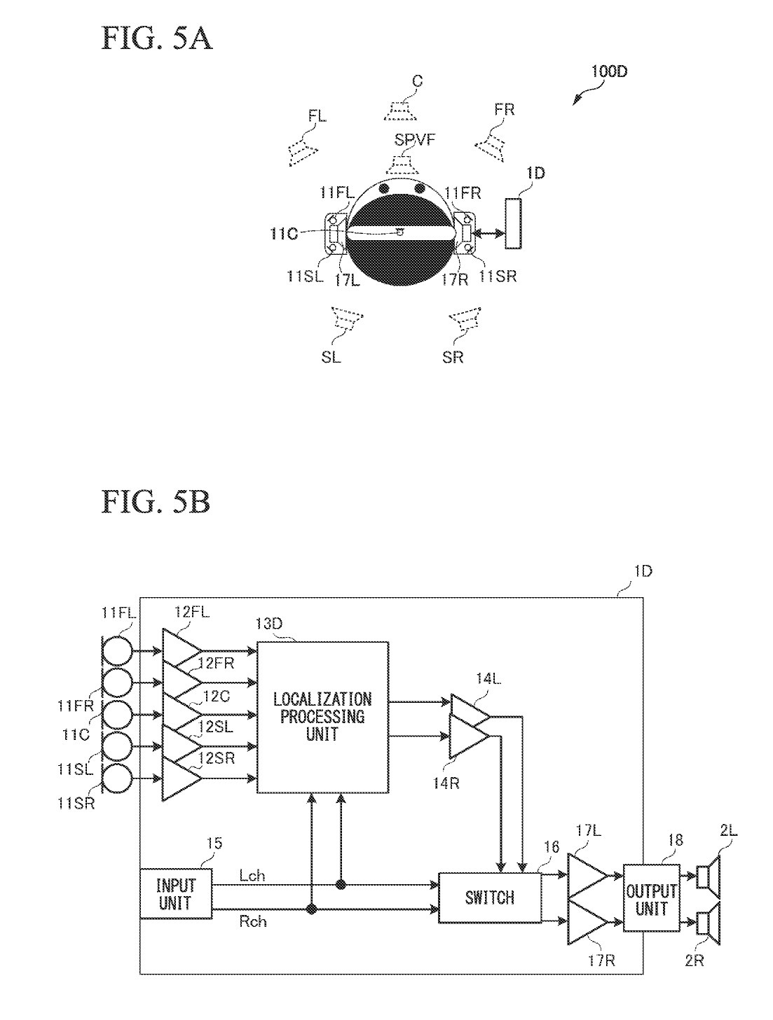

Next, FIG. 5A is a schematic diagram of a headphone 100D according to a fourth embodiment. FIG. 5B is a block diagram showing a configuration of a signal processing unit 1D according to the fourth embodiment. The headphone 100D is a sound-isolating type headphone.

Parts of the configuration shown in FIG. 5A and FIG. 5B similar to those in FIG. 4A and FIG. 4B are denoted by the same reference symbols, and explanation thereof is omitted.

The headphone 100D in this example includes five microphones, that is, a microphone 11FL, a microphone 11FR, a microphone 11SL, a microphone 11SR, and a microphone 11C. The five microphones 11FL to 11C are formed of directional microphones. The microphones 11FL to 11C acquire sound coming from different directions.

The microphone 11FL mainly acquires the sound of the ambient sound, coming from the left front of the listener. The microphone 11FR mainly acquires the sound of the ambient sound, coming from the right front of the listener. The microphone 11SL mainly acquires the sound of the ambient sound, coming from the left back of the listener. The microphone 11SR mainly acquires the sound of the ambient sound, coming from the right back of the listener. The microphone 11C mainly acquires the sound of the ambient sound, coming from the front of the listener.

A signal processing unit 1D includes a microphone amplifier 12FL, a microphone amplifier 12FR, a microphone amplifier 12SL, a microphone amplifier 12SR, and a microphone amplifier 12C that amplify sound-acquisition signals of the respective microphones. The respective microphone amplifiers 12FL to 12C input the amplified sound-acquisition signals to a localization processing unit 13D.

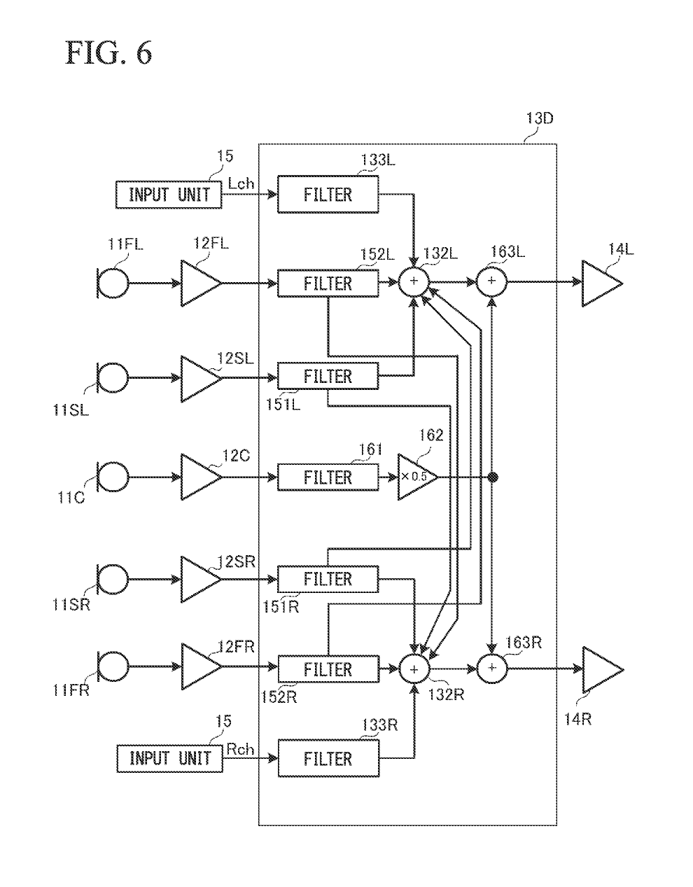

FIG. 6 is a block diagram showing a configuration of the localization processing unit 13D. The localization processing unit 13D includes a filter 152L, a filter 152R, a filter 161, a level adjuster 162, an adder 163L, and an adder 163R, in addition to the configuration of the localization processing unit 13C shown in FIG. 4B.

The filter 152L adds an HRTF (FL_{L}) corresponding to a direct route from a virtual loudspeaker FL at the left front of the listener to his or her left ear, to the sound-acquisition signal. The filter 152L inputs the sound-acquisition signal added with the HRTF (FL_{L}), to an adder 132L. Moreover, the filter 152L adds an HRTF (FL_{R}) corresponding to an indirect route from the virtual loudspeaker FL to the listener's right ear, to the sound-acquisition signal. The filter 152L inputs the sound-acquisition signal added with the HRTF (FL_{R}), to an adder 132R.

Similarly, the filter 152R adds an HRTF (FR_{R}) corresponding to a direct route from a virtual loudspeaker FR at the right front of the listener to his or her right ear, to the sound-acquisition signal. The filter 152R inputs the sound-acquisition signal added with the HRTF (FR_{R}), to the adder 132R. Moreover, the filter 152R adds an HRTF (FR_{L}) corresponding to an indirect route from the virtual loudspeaker FR to the listener's left ear, to the sound-acquisition signal. The filter 152R inputs the sound-acquisition signal added with the HRTF (FR_{L}), to the adder 132L.

The filter 161 adds an HTRF (C) corresponding to a route from a virtual loudspeaker C at the front of the listener to his or her left ear (and his or her right ear), to the sound-acquisition signal. The filter 161 inputs the sound-acquisition signal added with the HTRF (C), to the level adjuster 162. A distance between the virtual loudspeaker C and the listener is set farther than a distance between the virtual loudspeaker SPVF and the listener. Because of this, the listener can perceive that the sound from the virtual loudspeaker C and the sound from the virtual loudspeaker SPVF are emitted from respectively different positions.

The level adjuster 162 adjusts the level of the input sound-acquisition signal to 0.5 times, and the level adjuster 162 inputs the level-adjusted sound-acquisition signal to the adder 163L and the adder 163R. According to the adjustment, a situation where an in-phase component (sound equally coming from the front of the listener to the left and right ears) is amplified more than the other sound is prevented.

The adder 132L mixes an audio signal Lch added with the HTRF (F_{L}), the sound-acquisition signal of the microphone 11FL added with the HTRF (FL_{L}), the sound-acquisition signal of the microphone 11SL added with the HTRF (SL_{L}), the sound-acquisition signal of the microphone 11FR added with the HTRF (FR_{L}), and the sound-acquisition signal of the microphone 11SR added with the HTRF (SR_{L}). Similarly, the adder 132R mixes an audio signal Rch added with the HTRF (F_{R}), the sound-acquisition signal of the microphone 11FR added with the HTRF (FR_{R}), the sound-acquisition signal of the microphone 11SR added with the HTRF (SR_{R}), the sound-acquisition signal of the microphone 11FL added with the HTRF (FL_{R}), and the sound-acquisition signal of the microphone 11SL added with the HTRF (SL_{R}).

The adder 163L mixes a signal output from the adder 132L, with an output signal of the level adjuster 162 to generate an addition signal, and inputs the addition signal to a level adjuster 14L. Similarly, the adder 163R mixes a signal output from the adder 132R, with the output signal of the level adjuster 162 to generate an addition signal, and inputs the addition signal to a level adjuster 14R.

As a result, the localization processing unit 13D can localize the ambient sound on the left front side, in the virtual loudspeaker FL at the left front of the listener. Moreover, the localization processing unit 13D can localize the ambient sound on the left rear side, in the virtual loudspeaker SL at the left rear of the listener. Furthermore, the localization processing unit 13D can localize the ambient sound on the right front side, in the virtual loudspeaker FR at the right front of the listener. Moreover, the localization processing unit 13D can localize the ambient sound on the right back side, in the virtual loudspeaker SR at the right rear of the listener. Furthermore, the localization processing unit 13D can localize the ambient sound at the front, in the virtual loudspeaker C at the front of the listener.

Also in this example, the audio sound is localized at the position of the virtual loudspeaker SPVF at the front of the listener. However, the position is not limited thereto. The audio sound may be lateralized without performing the localization processing.

In this case, the listener can acquire information as to which direction the ambient sound is generated around the listener, including not only the sense of left and right direction but also the sense of direction including the front and back direction.

In the above description, a case in which the headphones 100 to 100D are the sound-isolating type has been described. However, the headphone is not limited thereto. The headphones 100 to 100D may be an ear inserting type, such as a canal type or an inner-ear type. The headphones 100 to 100D may also be a head mounting type. When the headphones 100 to 100D are the head mounting type, the microphone may be attached to a head band, to acquire the sound coming from the front of the listener.

### INDUSTRIAL APPLICABILITY

The present invention may be applied to a signal processing device, a headphone, and a signal processing method.

### REFERENCE SYMBOLS

1 Signal processing unit

2L, 2R Headphone unit

11 Microphone

12 Microphone amplifier

13 Localization processing unit

131L, 131R Filter

14L, 14R Level adjuster

15 Input unit

16 Switch

17L, 17R Headphone amplifier

18 Output unit

1. A signal processing device comprising:
an input circuit configured to accept an input of a sound-source signal;
a microphone configured to acquire ambient sound to generate a sound-acquisition signal;
a localization processor programmed to execute task to process at least one of the sound-source signal and the sound-acquisition signal so that a first position and a second position are different from each other, task to mix the sound-source signal and the sound-acquisition signal and task to generate an addition signal,
wherein the first position is a position where a sound image based on the sound-source signal is localized, and the second position is a position where a sound image based on the sound-acquisition signal being localized; and
an output circuit configured to output the addition signal.

2. The signal processing device according to claim 1, wherein the localization processor is programmed to add a head-related transfer function to at least one of the sound-source signal and the sound-acquisition signal so that the first position and the second position are different from each other.

3. The signal processing device according to claim 1, wherein
the microphone includes a plurality of microphones including first and second microphones,
the first microphone is configured to acquire sound coming from a first direction to generate a first sound-acquisition signal,
the second microphone is configured to acquire sound coming from a second direction to generate a second sound-acquisition signal, the second direction being different from the first direction, and
the localization processor is programmed to process the first and second sound-acquisition signals so that a sound image based on the first sound-acquisition signal is localized at a position away from the first microphone in the first direction and a sound image based on the second sound-acquisition signal is localized at a position away from the second microphone in the second direction.

4. The signal processing device according to claim 3, wherein the plurality of microphones are respectively directional microphones.

5. The signal processing device according to claim 1, wherein the output circuit is configured to output the addition signal to a headphone.

6. A headphone comprising:
the signal processing device an input circuit configured to accept an input of a sound-source signal;
a microphone configured to acquire ambient sound to generate a sound-acquisition signal;
a localization processor programmed to execute-task to process at least one of the sound-source signal and the sound-acquisition signal so that a first position and a second position are different from each other, task to mix-s the sound-source signal and the sound-acquisition signal and task to generate an addition signal,
wherein the first position is a position where a sound image based on the sound-source signal is localized, and the second position is a position where a sound image based on the sound-acquisition signal being localized; and
an output circuit configured to output the addition signal; and
a headphone circuit configured to emit sound based on the addition signal.

7. A signal processing method comprising:
accepting an input of a sound-source signal;
acquiring ambient sound to generate a sound-acquisition signal;
processing at least one of the sound-source signal and the sound-acquisition signal so that a first position and a second position are different from each other,
wherein the first position is a position where a sound image based on the sound-source signal is localized, and the second position is a position where a sound image based on the sound-acquisition signal is localized;
mixing the sound-source signal and the sound-acquisition signal to generate an addition signal; and
outputting the addition signal.
